(19) United States
(12) Patent Application Publication
(10) Pub. No.: US 2024/0003497 A1
(43) Pub. Date: Jan. 4, 2024

(54) HIGH-PRESSURE GAS CONTAINER AND DEVICE FOR DETECTING DEFORMATIONS OF THIS CONTAINER

(71) Applicant: FAURECIA SYSTEMES D'ECHAPPEMENT, NANTERRE (FR)

(72) Inventors: Benjamin LUCAS-LECLIN, PARIS (FR); Aldric MOUSSIER, BURNHAUPT LE BAS (FR)

(21) Appl. No.: 18/265,039

(22) PCT Filed: Dec. 3, 2021
(86) PCT No.: PCT/EP2021/084169

§ 371 Date: Jun. 2, 2023

(30) Foreign Application Priority Data
Dec. 4, 2020 (FR) 20 12702

(51) Int. Cl. F17C 13/02

(52) U.S. Cl. CPC F17C 13/02; F17C 2201/0109; F17C 2203/0604; F17C 2203/0621; F17C 2203/0658; F17C 2221/012; F17C 2223/0123; F17C 2250/0469; F17C 2270/0168

(57) ABSTRACT

A high-pressure gas container which comprises a composite wall defining a gas storage chamber, the composite wall comprising an inner lining and a carbon-fiber structure surrounding the inner lining. The high-pressure gas container comprises at least one electrical conductor extending in the composite wall or on an inner or outer face of the composite wall, the at least one electrical conductor comprising a connection element to connect to a detection device that detects deformations of the container.

### CROSS-REFERENCE TO RELATED APPLICATIONS

This application is the US national phase of PCT/EP2021/084169, which was filed on Dec. 3, 2021 claiming the benefit of French Application No. 20 12702, filed on Dec. 4, 2020, which is incorporated herein by reference in its entirety.

### TECHNICAL FIELD

The present disclosure relates to a device for detecting deformations for a high-pressure gas container, especially a hydrogen storage container.

### BACKGROUND

Such a hydrogen storage container is, for example, intended to equip a vehicle, especially a motor vehicle.

The device for detecting deformations is intended to monitor the mechanical strength of the container, in order, for example, to estimate its wear.

### SUMMARY

The disclosure especially aims to propose a detection device that is both economical and efficient.

For this purpose, the disclosure relates especially to a high-pressure gas container, especially a hydrogen container, comprising a composite wall defining a gas storage chamber, the composite wall comprising an inner lining and a carbon-fiber structure surrounding the inner lining, and wherein the high-pressure gas container comprises at least one electrical conductor extending in the composite wall or on an inner or outer face of the composite wall, the electrical conductor comprising a connection element to connect to a device that detects deformations of the container.

Such a detection device uses inexpensive technology, and the integration of the electrical conductor in the composite wall allows precise detections of deformations.

An assembly according to the disclosure may further include one or more of the following features, taken alone or according to any technically conceivable combination.
The electrical conductor is arranged according to one of the following arrangements: the electrical conductor extends in the inner lining, or on an inner face of the inner lining, opposite the carbon-fiber structure; the electrical conductor extends in the carbon-fiber structure, or on an outer face of the carbon-fiber structure opposite the inner lining; or the electrical conductor extends between the inner lining and the carbon-fiber structure.
The electrical conductor is folded into the shape of a U, the two branches of which extend parallel to one another, or the gas container includes two conductors extending parallel to one another.
The electrical conductor is made of a material selected between a copper alloy, a metal, or a polymer comprising conductive particles.
The composite wall includes a collar closed at the ends thereof by respective curved bottoms, the electrical conductor extending along the collar and/or at least one of the curved bottoms.
The collar has a general shape obtained by rotation about a longitudinal axis to form helical collar, wherein the electrical conductor is wound about the helical collar defined about the longitudinal axis.
The composite wall includes a fiberglass layer surrounding the carbon-fiber structure.
The electrical conductor is formed, over its length, by several parts of different nature, for example several parts made of different materials, and/or several parts having different reactions to temperature.

The disclosure also relates to an assembly of a high-pressure gas container as defined above, and a device for detecting deformations of the high-pressure gas container, wherein the electrical conductor is connected to the detection device in order to allow detection of deformations of the high-pressure gas container.

Optionally, the detection device includes a reflectometry device.

The disclosure finally relates to a vehicle, especially a motor vehicle, comprising a high-pressure gas container as previously defined.

### DESCRIPTION OF THE DRAWINGS

Other aspects and benefits of the disclosure will be brought to light on reading the following disclosure, given solely by way of non-limiting example and made with reference to the appended figures, among which:

FIG. 1 is a partial sectional perspective view of an assembly according to a first exemplary embodiment of the disclosure;

FIG. 2 is a partial sectional perspective view of a detail of an assembly according to a second exemplary embodiment of the disclosure;

FIG. 3 is a partial sectional perspective view of a detail of an assembly according to a third exemplary embodiment of the disclosure;

FIG. 4 is a partial sectional perspective view of a detail of an assembly according to a fourth exemplary embodiment of the disclosure;

FIG. 5 is a partial sectional perspective view of a detail of an assembly according to a fifth exemplary embodiment of the disclosure; and

FIG. 6 is a graph depicting reflectometry signals.

### DETAILED DESCRIPTION

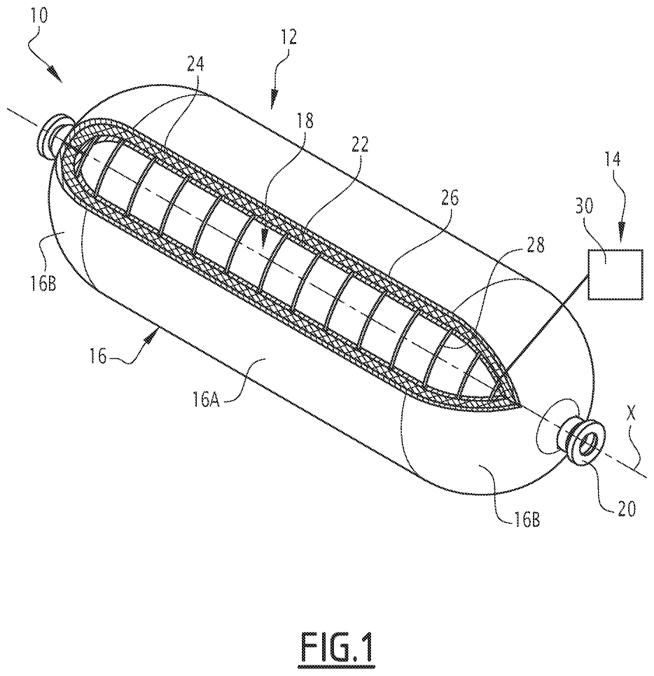

FIG. 1 depicts an assembly 10 of a high-pressure gas storage container 12 and a device 14 for detecting deformations of the container 12.

The storage container 12 is, for example, intended to store hydrogen under high pressure.

The storage container 12 includes a composite wall 16 defining a storage chamber 18.

The composite wall 16 includes, for example, a collar 16A closed at the ends thereof by respective curved bottoms 16B. One of the curved bottoms 16B conventionally includes a gas passage valve 20.

It should be noted that the curved bottoms are not always hemispherical (there can easily be several spokes having tangential profiles, for example). Reflectometry could also be applied to other container shapes, for example with baseplates having sinusoidal/polynomial profiles, etc.

The collar 16A preferably has a generally cylindrical shape defined along a longitudinal axis X. The storage container 12, for example, has a general shape obtained by rotation about the longitudinal axis X.

The composite wall 16 includes several layers disclosed below, from the inside to the outside.

The composite wall 16 first includes an inner lining 22, having a first inner face defining the storage chamber 18, and a first outer face radially opposite the first inner face.

The composite wall 16 then includes a carbon-fiber structure 24, surrounding the inner lining 22, having a second inner face in contact with the first outer face of the inner lining 22, and a second outer face radially opposite the second inner face.

The composite wall 16 then advantageously includes a fiberglass layer 26, surrounding the carbon-fiber structure 24, having a third inner face in contact with the second outer face of the structure 24, and a third outer face opposite the third inner face.

The composite wall 16 preferably includes an outer lining surrounding the fiberglass layer 26.

The detection device 14 includes at least one electrical conductor 28, for example an electrical cable 28, extending in the composite wall 16 or on an inner or outer face of the composite wall 16.

The detection device 14 includes, for example, a reflectometry device 30 connected to the electrical conductor 28.

The electrical conductor 28 extends along the collar 16A and/or at least one of the curved bottoms 16B.

For example, the electrical conductor 28 is wound about the helical composite wall 16 defined about the longitudinal axis X. The electrical conductor 28 preferably extends over the entire length of the composite wall 16.

Various examples of arrangement of the electrical conductor 28 are shown in FIGS. 1 to 5.

According to the embodiment of FIG. 1, the electrical conductor 28 extends in the inner lining 22. The electrical conductor 28 is therefore integrated into the inner lining 22 during the manufacture thereof.

In accordance with one variant not shown, the electrical conductor 28 extends against the first inner face of the inner lining 22.

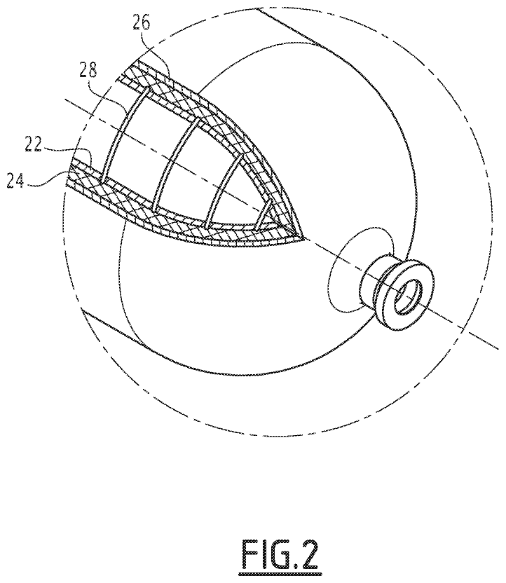

In accordance with the embodiment of FIG. 2, the electrical conductor 28 extends between the inner lining 22 and the carbon-fiber structure 24. In other words, the electrical conductor 28 extends on the first outer face of the inner lining and on the second inner face of the carbon-fiber structure 24. The electrical conductor 28 is then integrated during the assembly of the inner lining 22 and the carbon-fiber structure 24.

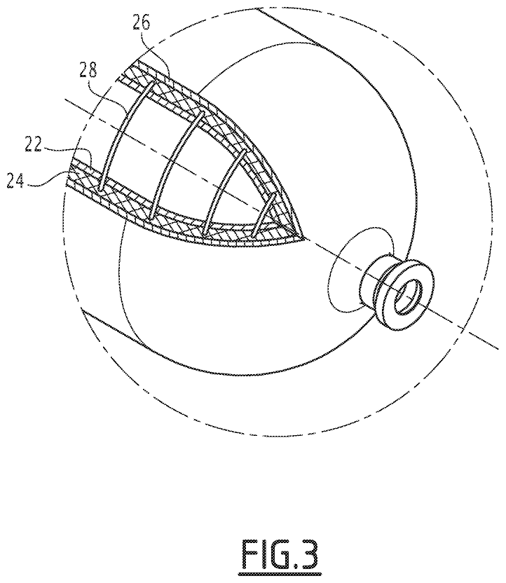

In accordance with the embodiment of FIG. 3, the electrical conductor 28 extends in the carbon-fiber structure 24. The electrical conductor 28 is therefore integrated into the carbon-fiber structure 24 during the manufacture thereof.

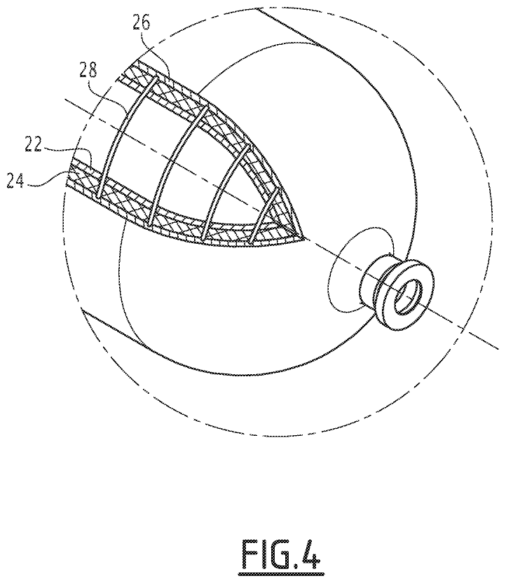

In accordance with the embodiment of FIG. 4, the electrical conductor 28 extends between the carbon-fiber structure 24 and the fiberglass layer 26. In other words, the electrical conductor 28 extends on the second outer face of the carbon-fiber structure 24. The electrical conductor 28 is then integrated during the assembly of the carbon-fiber structure 24 and the fiberglass layer 26.

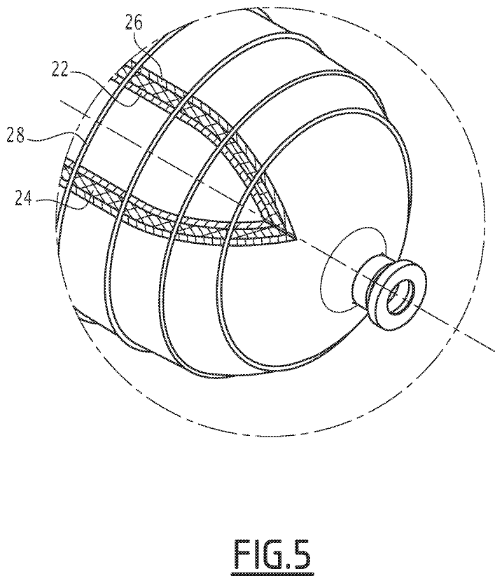

In accordance with the embodiment of FIG. 5, the electrical conductor 28 extends on the third outer face of the fiberglass layer 26. In this case, the electrical conductor 28 is preferably covered by the outer lining.

In accordance with one embodiment not shown, the electrical conductor 28 extends in the fiberglass layer 26. The electrical conductor 28 is therefore integrated into the fiberglass layer 26 during the manufacture thereof.

All these embodiments differ only by the position of the electrical conductor 28. The other features, especially those disclosed below, may be applied indistinctly to each embodiment.

The electrical conductor 28 is, for example, made of a material selected between a copper alloy, a metal or a polymer comprising conductive particles.

Advantageously, the electrical conductor 28 is formed, over its length, by several parts of different nature, for example several parts made of different materials, and/or several parts having different reactions to temperature.

In this case, each part of the electrical conductor has different conductivity and/or different sensitivity to temperature. This makes it possible to generate a singularity in the reflectometry trace.

It should be noted that an increase in the temperature of the wall 16 involves a mechanical elongation in this wall 16. An elongation may also be the consequence of a mechanical stress (external, internal pressure, etc.). The elongations in the wall 16 are therefore consequences of mechanical and thermal effects.

The arrangement of several conductor parts of different nature makes it possible to determine whether the elongation is due to a thermal effect or to a mechanical effect solely, or to both the mechanical and thermal effects. Indeed, each conductor part gives a curve or a value making it possible to solve an equation with one unknown. With several conductor parts placed end to end giving at least two curves or values making it possible to solve this system of equations with two unknowns, this makes it possible to deduce therefrom the contribution of each cause of deformation.

Advantageously, the electrical conductor 28 is folded into the shape of a U, the two branches of which extend parallel to one another. The two branches of the U are then spaced apart by a distance advantageously comprised between 0 and 20 mm, preferably by a distance substantially equal to 10 mm, this distance of 10 mm representing an optimal compromise for the best detection of deformations.

As a variant, the detection device 14 includes two electrical conductors extending parallel to one another. These two electrical conductors are then spaced apart by a distance advantageously between 0 and 20 mm. In this case, the detection device 14 includes two electrical conductors, the two ends of the conductors can be free at the end thereof, or contiguous, or connected with an electrical component having an electrical resistance.

The operation of the electrical reflectometry device is known per se. It can be carried out conventionally by using an oscilloscope vector network analyzer or packaged reflectometers (especially an electronic board or a control suitcase).

The reflectometry device sends a frequency spectrum or pulse that propagates along the branches of the U-shaped conductor 28 or the parallel conductors, and listens to the return signal. The analysis of the return signal makes it possible, in a manner known per se, to give the position of a fault generating an echo, by measuring the transit time.

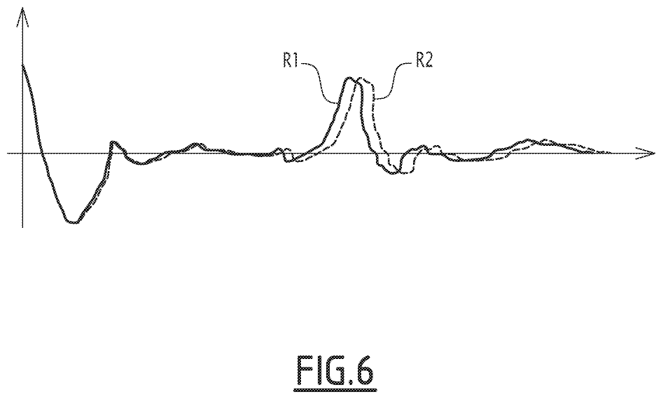

The reflectometry device according to the disclosure is configured to save at least one reference reflectometry curve R1, R2 (depicted in FIG. 6). A reflectometry curve has, on the X-axis, the distance along the electrical cable and, on the Y-axis, the measured impedance (or alternatively another characteristic of an electrical conductor).

In FIG. 6, the curve R1 depicts the reflectometry curve at the output of the production line. This curve has fluctuations depicting, for example, residual tensions in the composite wall.

The curve R2 is another reference curve, corresponding to a full container. This container is then subjected to tensions due to the presence of the compressed gas, involving a general elongation, local variations and possibly defects, so that there is an offset between the curve R1 and the curve R2.

It is possible to provide other reference curves based on the filling rate of the storage chamber 18, or to extrapolate such reference curves from the curves R1 and R2.

The detection of deformations is carried out during the life of the container 12, by generating new reflectometry curves, and by comparing them with the one or more reference curves.

A deformation of the container 12 is thus detected in the event of a mismatch between a measured reflectometry curve and the appropriate reference curve. Such a deformation is for example a local micro-elongation.

According to the principle of reflectometry, the mismatch zone on the curve appears to make it possible to know the deformation zone of the container 12, which makes it possible to facilitate the production of a diagnosis in the case that a deformation is detected.

The intensity of the mismatch also makes it possible to establish the intensity of the deformation.

It should be noted that the integration of the electrical cable 28 into the composite wall 16 allows precise monitoring of this composite wall 16. Any fluctuation in the electrical cable 28 indeed corresponds to a tension in the composite wall 16.

It should be noted that the reflectometry device 30 can be integrated into the container 12, or alternatively arranged at a distance, for example by being integrated into the vehicle.

According to another variant, the reflectometry device 30 is arranged on a stationary facility, external to the vehicle, for example at a service station. In this case, the reflectometry device 30 must be connected to the electrical cable 28 in order to detect deformations.

The connection is then carried out during a monitoring or maintenance operation. In this case, a person removes a plastic cap from the container in order to access an electrical connector and connect the external reflectometry device 30.

The connection can also be established during refueling operations. In this case, the refueling pistol includes a first connector, and the vehicle includes a second connector, the two connectors being connected during the connection, the reflectometry device then being able to freely query the state of health of the container.

The disclosure has been shown and described in detail in the drawings and the preceding description. This must be considered as illustrative and given by way of example and not as limiting the disclosure to this only description. Many alternative embodiments are possible.

1. A high-pressure gas container comprising:
a composite wall defining a gas storage chamber, the composite wall comprising an inner lining and a carbon-fiber structure surrounding the inner lining, wherein the high-pressure gas container comprises at least one electrical conductor extending in the composite wall or on an inner or outer face of the composite wall, the at least one electrical conductor comprising a connection element to connect to a detection device that detects deformations of the high-pressure gas container.

2. The high-pressure gas container according to claim 1, wherein the at least one electrical conductor arranged according to one of the following arrangements:
the at least one electrical conductor extends in the inner lining, or on an inner face of the inner lining, opposite the carbon-fiber structure;
the at least one electrical conductor extends in the carbon-fiber structure, or on an outer face of the carbon-fiber structure opposite the inner lining; or
the at least one electrical conductor extends between the inner lining and the carbon-fiber structure.

3. The high-pressure gas container according to claim 1, wherein the at least one electrical conductor is folded into a shape of a U having two branches of which extend parallel to one another.

4. The high-pressure gas container according to claim 1, wherein the at least one electrical conductor is made of a material selected from a copper alloy, a metal, or a polymer comprising conductive particles.

5. The high-pressure gas container according to claim 1, wherein the composite wall includes a collar closed at ends thereof by respective curved bottoms, the at least one electrical conductor extending along the collar and/or at least one of the respective curved bottoms.

6. The high-pressure gas container according to claim 5, wherein the collar has a general shape obtained by rotation about a longitudinal axis to form a helical collar, wherein the at least one electrical conductor is wound about the helical collar defined about the longitudinal axis.

7. The high-pressure gas container according to claim 1, wherein the composite wall includes a fiberglass layer surrounding the carbon-fiber structure.

8. The high-pressure gas container according to claim 1, wherein the at least one electrical conductor is formed, over a length, by several parts of different nature.

9. An assembly of a high-pressure gas container according to claim 1, and the detection device to detect deformations of the high-pressure gas container, wherein the at least one electrical conductor is connected to the detection device in order to allow detection of deformations of the high-pressure gas container.

10. The assembly according to claim 9, wherein the detection device includes a reflectometry device.

11. A vehicle, especially a motor vehicle, comprising a high-pressure gas container according to claim 1.

12. The high-pressure gas container according to claim 1, wherein the at least one electrical conductor comprises two conductors extending parallel to one another.

13. The high-pressure gas container according to claim 1, wherein the at least one electrical conductor is formed, over a length, by several parts made of different materials, and/or several parts having different reactions to temperature.

14. The high-pressure gas container according to claim 1, wherein the high-pressure gas container comprises a hydrogen container.
